(19) United States
(12) Patent Application Publication
(10) Pub. No.: US 2011/0063341 A1
(43) Pub. Date: Mar. 17, 2011

(54) METHOD AND SYSTEM FOR CORRECTION, MEASUREMENT AND DISPLAY OF IMAGES

(76) Inventors: Wendell Knicely, Bedford, MA (US); Eugene R. Harris, Groton, MA (US); Peter M. Steven, Cambridge, MA (US)

(21) Appl. No.: 12/883,004

(22) Filed: Sep. 15, 2010

Related U.S. Application Data
(60) Provisional application No. 61/242,744, filed on Sep. 15, 2009.

(51) Int. Cl. G09G 5/10; G09G 3/36

(52) U.S. Cl. 345/690; 345/102

(57) ABSTRACT

One aspect of the invention is a system for displaying images. A display device comprises a back light unit and a first aperture and a second aperture in the back light unit. The display device also comprises a first sensor, a second sensor, and a third sensor. The first sensor is configured to measure a first brightness value of the back light unit through the first aperture. The second sensor is configured to measure a second brightness value of the back light unit through the second aperture. The third sensor is configured to measure a third brightness value from a front portion of the display device.

### CROSS REFERENCE TO RELATED APPLICATIONS

This application claims priority under 35 U.S.C. §119 to U.S. Appl. No. 61/242,744, filed Sep. 15, 2009, the disclosure of which is incorporated herein by reference.

### FIELD OF THE INVENTION

The present invention relates generally to backlit display systems, such as liquid crystal displays (LCDs).

### INCORPORATION BY REFERENCE

All publications and patent applications mentioned in this specification are herein incorporated by reference to the same extent as if each individual publication or patent application was specifically and individually indicated to be incorporated by reference.

### BACKGROUND OF THE INVENTION

There are several methods of controlling the back light brightness and a similar number of methods of measuring the conformance of the display to a particular response curve, such as DICOM Grayscale Display Function (GSDF). Each of these methods has limitations on the ability to control the brightness accurately and report the results correctly to the user. Given that the response curve of the display is always measured from the front center of the display, all methods which do this automatically without use of a separate photometer do so by inference about center response function based on data from sensors placed elsewhere.

A first method uses a single photometer mounted at the center of the display that reads only the back light brightness through an aperture in the back light unit (BLU) of the display. This method is simple and measures the brightness at the center of the display. It has the unfortunate disadvantage of not viewing from the front of the display directly and therefore is not able to detect variances of the display unit.

A second method uses a photometer (or other light detector) measuring from the front of the display off to the side of the active display area. This method has the disadvantage of measuring the display at the sides of the active area when the user is concerned about the image at the center of the display. The aging of typical back lights (and in particular cold cathode fluorescent lamps or CCFLs) is considerably different at the edges of the monitor than at the center, causing the measurements to drift.

A third method uses both a sensor in front of the display and one behind the BLU. This method provides some additional data for back light control and conformance testing, but retains most of the disadvantages of the other two methods, i.e., back light measurements are not measuring the front, front side measurements are not measuring the center, and both measurements are subject to drift.

### SUMMARY

One aspect of the invention relates to a system for displaying images for medical use. The system maintains the brightness level of the display at a fixed brightness in real time and measures the display's conformance to display standards such as DICOM. In one embodiment, the system uses three sensors to correct readings made at the edge of backlit displays. The sensors may be placed with one behind the center of the BLU, one on the edge of the front of the display, and a third sensor behind the BLU directly behind the front sensor. The placement of the front sensor minimizes interference with the active image and maximizes image quality. The invention is not dependent on this specific placement or number of sensors, but more generally with a sensor system to provide feedback to improve front sensor readings.

One aspect of the invention relates to a system and method of measuring and monitoring a display system. The system and method includes real time measurement and correction of the display system's conformance to standards such as but not limited to DICOM. The display system corrects any variations resulting from aging of the display system. In particular, the display system corrects brightness and response function which may vary with time and aging conditions. The display system provides unobtrusive measurement and control. This method is different from other multi-sensor approaches used to control multiple light sources, as in projection displays. (See U.S. Pat. No. 7,618,147 and US Patent Publ. No. 2006/0132910.)

Another aspect of the invention relates to a novel technique for collecting the data and evaluating the sensor data to achieve greater accuracy. The software and hardware techniques allow better data collection and better interpretation for use in inferring readings from the center of the display. This method depends in part on the configuration of the sensors as outlined herein, and in part in the interpretation of the observed sensor data. Sensor placement and configuration can cause luminance readings to be affected by light hitting the sensor at an angle off perpendicular. Off-angle light contributions can be particularly misleading when measuring LCD displays where luminance has a significant angular component. This method addresses off angle contributions differently from prior art. (See, e.g., U.S. Pat. No. 7,038,186).

Another aspect of the invention relates to the measurement of ambient light. The front sensor can be calibrated to infer ambient light based on variations in sensor readings with no change in the display configuration. This approach is significantly different from traditional single and multi-sensor methods for measuring ambient light. In the prior art sensors are added to directly measure ambient light (see US Patent Appl. No. 2008/0078921) or indirectly measure ambient light through the LCD (see U.S. Pat. No. 7,068,333 and US Patent Appl. No. 2006/0181673). This approach has the advantage of measuring ambient light reflected off the display rather than measuring the ambient directly. It is the reflected ambient light that is important for correcting display appearance.

In one aspect, a system for displaying images is provided. A display device comprises a back light unit and a first aperture and a second aperture in the back light unit. The display device also comprises a first sensor, a second sensor, and a third sensor. The first sensor is configured to measure a first brightness value of the back light unit through the first aperture. The second sensor is configured to measure a second brightness value of the back light unit through the second aperture. The third sensor is configured to measure a third brightness value from a front portion of the display device.

At least a part of the first aperture is at the center of the back light unit of the display device. At least a part of the second aperture is at an edge of the back light unit of the display device.

The display device comprises a test area and an active area, the third sensor being configured to measure brightness of the test area. The third sensor is further configured to measure ambient light reflected off the test pattern area.

The display system comprises a test pattern generator coupled to the test area. The system also comprises a conformance test system coupled to the test area and the test pattern generator to evaluate and monitor the display device's conformance to a specified output display function. The conformance system is coupled to a host computer device, the host computer device being adapted to evaluate and monitor the display device's conformance to a specified output display function.

Further, the display system comprises a back light control system coupled to the first sensor, the second sensor, and the third sensor. The back light control system is configured to regulate brightness of the display device.

In another aspect, a method of monitoring and maintaining a display system is provided. The method comprises measuring a first sensor reading of a back light unit in the display system through a first aperture. The method also comprises measuring a second sensor reading of the back light unit through a second aperture and measuring a third sensor reading from a test pattern area in the display system. The method further comprises collecting the first, second and third sensor readings and regulating brightness of the display system based on the collected sensor readings as well as determining a correct setting of the back light unit. Measuring a sensor reading may comprise measuring a first brightness value, a second brightness value and a third brightness value.

The method further comprises measuring ambient light reflected off a test pattern area on the display system and compensating for off-angle luminance of the display system.

Yet further, the method comprises evaluating and monitoring the display system's conformance to a specified output display function.

Another aspect of the invention is a method of characterizing a display system. The method comprises setting a test pattern on the display system and setting a test area in the display system to a first driving level. The method further comprises measuring a first sensor reading of a back light unit in the display system through a first aperture, measuring a second sensor reading of the back light unit through a second aperture, measuring a third sensor reading from a front portion of the display system and measuring an external photometer reading of the display system. Measuring at least one of the readings comprises measuring a brightness value.

The method also comprises determining characterization data based on the measured readings and storing characterization data in the display system.

If there are more driving levels to test, the method comprises setting the test pattern on the front of the display system and setting the test area in the display system to a next driving level. Thereafter, all the sensor and photometer readings are measured. Characterization data is determined based on the measured readings and stored after the iteration process, if any, on the display system.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 illustrates one embodiment of a display system.

FIG. 2 illustrates characterization of a display system using a flow chart.

FIG. 3 illustrates a wider field of view from a front sensor.

FIG. 4 illustrates ambient light reflecting to a front sensor.

### DETAILED DESCRIPTION

The display system of this invention may be used in the area of medical systems which provide information and requires an accurate display of the image. In these medical systems, it is often important to verify conformance of the display function to industry standards, such as DICOM. The display function is the mapping of digital pixel values to display luminance. The standards such as DICOM prescribe a display function to maximize visible details in the medical image as well as provide a consistent image presentation when displayed on conformant monitors.

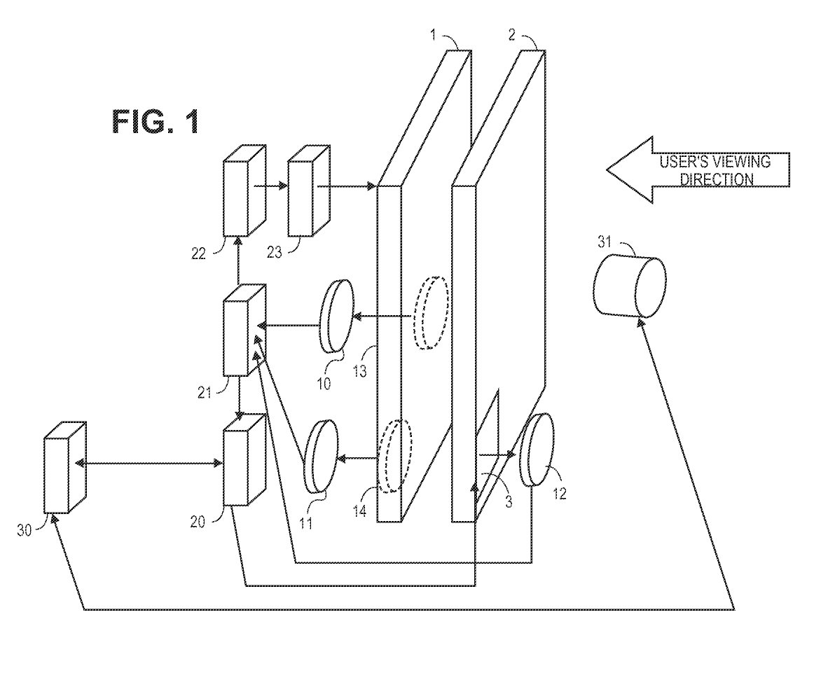

FIG. 1 illustrates one embodiment of the display system. In FIG. 1, the display device has a LCD active area 2 and test pattern area 3. The test pattern area 3 may be either a dedicated area of the display device outside the active area or part of the active area of the display. A BLU control unit, including control logic 22 and control hardware 23, is capable of driving the overall brightness of the display. A sensor 10 preferably mounted over an aperture 13 in the center of the back of the BLU 1, can read the brightness of the back light at the center of the display. A sensor 12 mounted over the test pattern area 3 can read the brightness of the test pattern area. A sensor 11 preferably mounted over an aperture 14 in the back of the BLU directly behind the front sensor 12 can read the brightness of the back light at the edge of the display. The sensor control circuit 21 collects sensor readings from sensors 10, 11, and 12. The sensor data is aggregated by the BLU control logic 22 and used to determine the correct setting for the BLU control hardware 23 to maintain a preset brightness.

The sensors 11 and 12 can also be used under the control of a host computer 30 outside the monitor through the monitors display control 20. The host computer 30 can read the front sensor 12 over the test area 3 with brightness patterns set by the host computer 30 to test the display's conformance with grayscale display function, such as DICOM. The host computer 30 also uses the side sensor 11 to correct for differences in the brightness of the center of the display, as read by sensor 10, and the side of the display due to BLU aging.

An external photometer or like measurement device 31 may be used during the characterization process of the panel, such as after manufacture and prior to use of the monitor in a medical environment. The photometer 31 used is specifically selected to have a very narrow viewing angle, so off-angle luminance from the LCD contributes minimally to the readings. A linear correlation of back sensor 10 readings to photometer 31 readings is determined. A similar linear correlation of side sensor 11 readings to photometer 31 and back sensor 10 readings is also determined. The test area 3 may be set to any pattern for testing, though the test area is often set to a single solid color or gray shade. The gray shade is selected by setting a digital value in a display frame buffer. This digital value sets the driving voltage or driving level of the liquid crystal display element or pixel. The driving level of the pixel causes the liquid crystal to twist which determines the amount of light visible at that pixel. Accordingly, the driving level may be a level or magnitude of the electrical signal provided to the LCD. To achieve a unique brightness, each pixel of the LCD can have a specific driving level.

Finally, a functional relationship between front sensor 12 readings and test area 3 driving levels is made with the photometer 31 readings over a center test pattern at the same driving levels. The off-angle luminance contribution is a stable characteristic of the particular LCD 2 and is dependent on the LCD's construction and the driving level of the test pattern. Because the off-angle contribution is stable over time, a previously unknown and unexploited fact, the contribution will be consistent for any given driving signal. This functional relationship between the front sensor readings and test area driving levels can be characterized as a function F(x, y) such that for any front sensor 12 reading, x, and test area 3 driving level, y, the true photometer reading over a center test pattern at the same driving level can be predicted accurately. This empirically derived F(x,y) can be stored within the device, e.g., as a look-up table, and used to adjust light levels during use of the monitor, as explained below.

The function, F(x, y) allows for accurate interpretation of front sensor 12 readings, compensating for the off-angle contributions of the luminance from the LCD 2. In the past, correcting for off-angle contributions to a sensor has been challenging. Methods provided to date generally rely on reducing the amount of off-angle light reaching the sensor (see U.S. Pat. No. 7,038,186). The sensor characterization method described herein allows for direct reading and interpretation of front sensor 12 data even in the presence of off-angle luminance contributions.

The display control 20 can also initiate a conformance internal to the monitor in the same way the remote host computer 30 would. In this way, the display can self-monitor its conformance state, indicating its state to the user, communicating it to the host computer (30), or holding its own history for future status requests.

The sensors 10, 11, and 12 may be simple sensors or fully calibrated photometers. The sensors 10, 11, and 12 may be (but not limited to) a direct reading photometer, and indirect unit using optics, or a temporarily moved photometer via manual or automatic means (i.e., a wiper unit). The sensors 10 and 11 may be placed internally in the display.

In the illustrated embodiment, the aperture beneath sensor 10 for viewing the BLU brightness is located such that the center of the active area of the display (in both x and y directions) is measured by sensor 10. The aperture 13 is often circular, but may be any shape.

In the illustrated embodiment, the aperture 14 beneath sensor 11 for viewing the BLU brightness is located at the edge of the display. The aperture may be located such that sensor 11 can measure the display directly beneath the test area 3 and sensor 12, though this is not necessary, as long as the location of the aperture provides sufficient information to estimate aging effects of the BLU beneath the test area.

The test area 3 is either a dedicated test pattern area or part of the active display area temporarily available from the active display area. The test area 3 receives patterns of brightness from the display control unit 20. The test area 3 is different from the rest of the active area of the display because the test area can be forced to hold a single brightness value, regardless of the normal pixel data being sent from the host computer 30. The control of the test area 3 allows the display control 20 to reliably read and interpret the front sensor 12. The test area 3 is often rectangular, but may be of any shape.

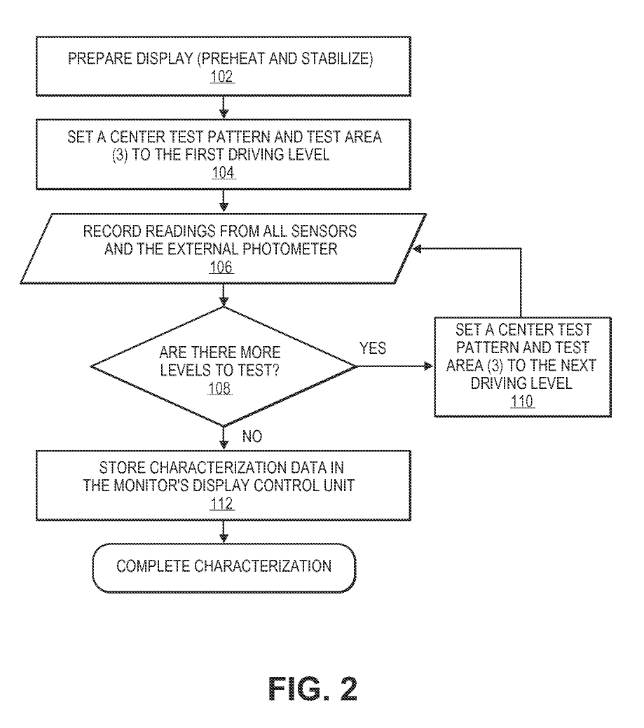

The system may be characterized through a process 100 described in the flow chart of FIG. 2. After preparing the display (e.g., by preheating and stabilizing) 102, an external photometer (ideally calibrated to national and international standards as required) reads test patterns at a first driving level on the front center of the display, as shown in steps 104 and 106. Simultaneously the test area is set to the same pattern, usually a solid gray shade.

Characterization proceeds by stepping through a full range of gray shades or luminance values, as shown in the loop 108 and 110. Readings are taken from the front sensor as well as from the calibrating photometer. A function is developed from the full set of readings, such that given a reading from the front sensor, x, over the test area shade of gray, y, yields the corresponding value F(x,y) equal to the photometer measurement of the same shade of gray displayed in the center of the display. The function is stored in the display control unit, as shown in step 112. The function represents a characterization of the behavior of the LCD and each of the sensors at every gray shade or driving level. Accordingly, characterization data maybe the information that is unique to a specific display which defines changes to the LCD driving level that will allow the display to conform to the DICOM GSDF (or equivalent standards). Thus, the characteristic data is read and stored with the monitor, such that it can be recalled at any time to predict center photometer readings from front sensor readings over known test area driving levels, and manage the display accordingly. The characteristic data can be collected for a group of displays with the average response stored in the monitor or host computer, but this is a significantly inferior solution as a key to the compensation for off-angle light contribution depends on the characteristics of a particular monitor and not a general class of monitors.

The initial system characterization also collects readings from the BLU sensors 10 and 11 in a similar manner to develop F(x,y). The BLU 1 brightness directly determines the brightness seen through the LCD 2. The functional relationship between the back light sensor readings and the photometer readings is usually, though not necessarily, assumed to be a simple linear relationship. The brighter the BLU 1, the brighter the LCD 2. Full white as measured by the external photometer 31 during initial characterization is thus typically a simple multiple of the BLU 1 brightness as read from the center sensor 10. The proportional relationship allows the LCD 2 center brightness to be set to a precise value by reading the center sensor 10 and iteratively adjust the BLU 1 brightness through the BLU control hardware 23. By this method the back light brightness can be stabilized to produce consistent display brightness.

Likewise, the simple model of BLU 1 characterization and control can be further enhanced if the BLU control logic 22 also considers the current front sensor readings 12 with a known test pattern set in the test area 3. Here the luminance function, F(x,y), is used to determine whether the luminance of the LCD 2 is as expected for the given BLU 1 brightness. If not, the BLU control logic 22 may choose to modify the simple brightness adjustment factor to achieve back light brightness stabilization.

BLU's often age non-uniformly. Typically the edges of the BLU will dim sooner than the center. The side sensor 11 can provide information about the display's aging by comparing the relationship between the side sensor 11 and the center sensor 10 readings with that observed during the characterization of the monitor. The BLU control logic 22 can choose to use the side sensor 11 readings for back light brightness stabilization if the current sensor readings lead the BLU control logic 22 to doubt the reliability of the center sensor 10. The multi-sensor method of back light brightness stabilization allows the BLU control logic 22 great flexibility and robust performance with redundant sensor readings and a variety of viable strategies for BLU control.

The side sensor 11 also provides additional information to refine the front sensor 12 reading function, F(x,y). If the BLU 1 has dimmed toward the edges due to aging, the side sensor 11 can indicate the degree of dimming and provide information to compensate front sensor 12 readings. The combination of multiple sensors provides more information and thus a more reliable measurement mechanism than other front sensor systems described previously.

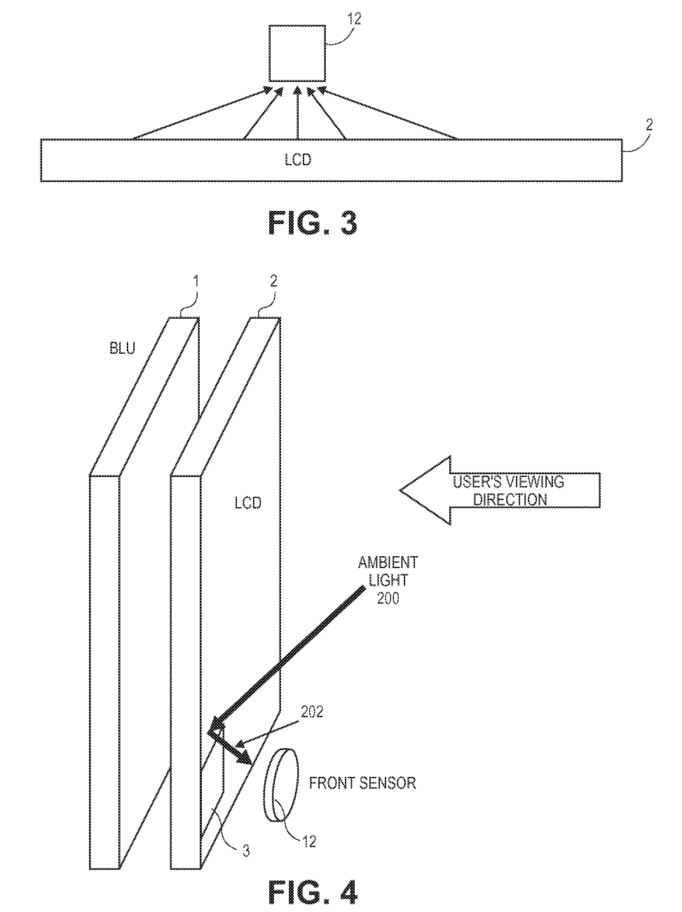

The light coming off of an LCD has an angular dependency. Typically the perpendicular luminance at any given location on the LCD 2 is different from the off-angle measurement of the same location. This is not true of many dispersive light sources, but it is a well known characteristic of LCDs. Including off-angle light contributions to a LCD sensor reading will not typically give an accurate luminance measure. (See FIG. 3). Traditional front sensor and photometer reading strategies employ techniques to narrow the acceptance angle of the sensor, however this results in much less light reaching the sensor making precise readings difficult, particularly at low light levels. For any given manufacturing technique, the off-angle contribution is largely determined by the twist applied to the liquid crystal, which in turn is determined by the gray shade used to drive the pixels. The characterization process employed here not only characterizes the brightness of the display at given gray shades, but also characterizes the off-angle contribution at each gray shade driving level. Because the gray shade is specifically selected and known, the twist is known, and the off-angle contribution is therefore predictable based on the observed measurements.

The front sensor 12 characterization and reading methodology allows the system to make exceptionally accurate front readings. This is due in part to the characterization process that maps the full response of the display 2 at the center to the response as measured at the front sensor 12 and in part to the adjustment that can be made using the side sensor 11 readings. The additional enhancement of this method is the ability to include a wider field of view from the front sensor 12, as in FIG. 3, because the off-angle contribution for any given gray shade setting is known. Thus, more light can be used to make a front sensor reading, making those readings more precise. This is particularly true when making measurements of low luminance levels near black.

With precise front sensor 12 readings, the display control 20 can read the brightness over a range of gray shades and compare the readings with a target display function such as DICOM GSDF. The display control 20 can automatically check the display function conformance without user intervention.

With the enhanced precision of the front sensor readings, the front sensor can, in some cases, be used to measure the ambient light hitting the display. For some displays in some environments and some display function standards, such as DICOM, ambient light measurements can be considered in creating the ideal display function. If the front sensor 12 is set to measure a black pattern in the test area 3, readings above the expected results could be attributed to the ambient light. This is not a particularly precise way to measure ambient light. However, the requirements for assessing ambient light are often quite crude, and using the front sensor 12 to make the measurements is not only adequate, but actually preferred because most or all of the ambient light reaching the sensor is being reflected off the surface of the LCD 2 into the front sensor 12. Reflected ambient light, not absolute ambient light, is the determinate of the impact of the ambient light, and thus the determinate of the degree of additional compensation that need be applied. This aspect of the invention is illustrated in FIG. 4, which shows ambient light 200 reflecting 202 to front sensor 12. In FIG. 4, a significant amount of the incoming ambient light 200 may not be reflected light 202, and thus may not reach the front sensor 12. However, the ideal ambient light measurement may be the reflected ambient light and not necessarily the total ambient light. To enhance the measurement of the reflected ambient light, the BLU 1 can be turned off to remove any light coming directly from the LCD 2.

All of the sensor readings, gray shade response curve control, and back light control have been described as controlled by the display control unit 20 inside the monitor. However, the host computer 30 can access all of this functionality as well and provide the control functions in software rather than hardware. The software can also simply monitor the hardware's behavior and state, and make that information available to the user or to a network application for more broadly integrated display management.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for displaying images comprising:
a display device comprising a back light unit and a first aperture and a second aperture in the back light unit; and
a first sensor, a second sensor, and a third sensor, wherein the first sensor is configured to measure a first brightness value of the back light unit through the first aperture, wherein the second sensor is configured to measure a second brightness value of the back light unit through the second aperture, and wherein the third sensor is configured to measure a third brightness value from a front portion of the display device.

2. The system of claim 1, wherein at least a part of the first aperture is at the center of the back light unit of the display device.

3. The system of claim 1, wherein at least a part of the second aperture is at an edge of the back light unit of the display device.

4. The system of claim 1, wherein the display device comprises a test area and an active area, the third sensor being configured to measure brightness of the test area.

5. The system of claim 4, further comprising a test pattern generator coupled to the test area.

6. The system of claim 5 further comprising a conformance test system coupled to the test area and the test pattern generator to evaluate and monitor the display device's conformance to a specified output display function.

7. The system of claim 6, wherein the conformance system is coupled to a host computer device, the host computer device being adapted to evaluate and monitor the display device's conformance to a specified output display function.

8. The system of claim 4, wherein the third sensor is further configured to measure ambient light reflected off the test area.

9. The system of claim 1 further comprising a back light control system coupled to the first sensor, the second sensor, and the third sensor, wherein the back light control system is configured to regulate brightness of the display device.

10. A method of monitoring and maintaining a display system comprising:
measuring a first sensor reading of a back light unit in the display system through a first aperture;
measuring a second sensor reading of the back light unit through a second aperture;
measuring a third sensor reading from a test area in the display system;
collecting the first, second and third sensor readings; and
regulating brightness of the display system based on the collected sensor readings.

11. The method of claim 10, wherein measuring a first sensor reading comprises measuring a first brightness value.

12. The method of claim 10, wherein measuring a second sensor reading comprises measuring a second brightness value.

13. The method of claim 10, wherein measuring a third sensor reading comprises measuring a third brightness value.

14. The method of claim 10, further comprising measuring ambient light reflected off the test area.

15. The method of claim 10, further comprising compensating for off-angle luminance of the display system.

16. The method of claim 10, further comprising evaluating and monitoring the display system's conformance to a specified output display function.

17. The method of claim 10, further comprising determining a correct setting of the back light unit.

18. A method of characterizing a display system comprising:
setting a test pattern on the display system and setting a test area in the display system to a first driving level;
measuring a first sensor reading of a back light unit in the display system through a first aperture;
measuring a second sensor reading of the back light unit through a second aperture;
measuring a third sensor reading from a front portion of the display system;
measuring an external photometer reading of the display system; and
determining characterization data based on the measured readings and storing characterization data in the display system.

19. The method of claim 18, further comprising setting the test pattern on the front of the display system and setting the test area in the display system to a second driving level.

20. The method of claim 18, wherein measuring at least one of the readings comprises measuring a brightness value.
